(19) United States
(12) Patent Application Publication
(10) Pub. No.: US 2002/0007494 A1
(43) Pub. Date: Jan. 17, 2002

(54) Interactive digital program material encoder and system

(76) Inventor: Winston W. Hodge, Yorba Linda, CA (US)

Correspondence Address: Michael A. Kerr, Virtual Legal, P.O. Box 2345, Stateline, NV, 89449, US

(21) Appl. No.: 09/858,192

(22) Filed: May 14, 2001

Related U.S. Application Data
(63) Continuation of application No. 09/162,313, filed on Sep. 28, 1998, now abandoned.

(51) Int. Cl. H04N 7/173; H04N 7/20

(52) U.S. Cl. 725/109; 725/63; 725/1

(57) ABSTRACT

An encoder to be located at the head end of a television program material distribution center. The encoder maps relatively large Ethernet addresses to smaller MPEG-2 address spaces by converting the Internet address to a number uniquely associated with program material. MPEG-2 frames created in this manner are placed in radio frequency slots within the frequency space occupied by a single analog television program. All types of Ethernet data, including Internet data, video program material from sources such as Microsoft NetShow Theater, digital audio and the like can all be converted to MPEG-2 bitstreams. This overcomes and reduces communications incompatibilities and complexities among set top boxes and existing head end because all digital set top boxes are designed to handle MPEG-2 data frames. The encoder provides the ability and necessary ingredient to provide dynamic linkage between Internet IP addresses and MPEG2 PID addresses permitting simultaneous connected operations between the Internet and Interactive TV programming accommodating interactive mediums spread across both environments. Several encoders may have radio frequency outputs stacked by a combiner and transmitted as a single wideband signal to build larger systems. The encoder can dynamically produce multiple content streams from a single stream from video servers or satellites, either time displaced or not, thereby reducing the costly bandwidth production requirements of video servers and satellites. This allows multiple threads of video program material to be transmitted simultaneously or multiple copies of the same thread to be transmitted with time delays between threads for either video-on-demand (VOD) or near-video-on-demand (NVOD) applications. The encoder dynamically balances bandwidth requirements between Internet, digital television and telephony applications by measuring actual bandwidth utilization and reallocating digital bandwidth and spectrum allocation automatically. This is implemented by the automatic spectrum allocation function and the digital multiplexing functions under firmware and software control and is facilitated by a closed loop feedback control algorithm.

### TECHNICAL FIELD

The invention relates to data communications, and in particular, to transmission and re-transmission of multi-format data, particularly Internet data and interactive digital television data, either linked or not linked to set top boxes.

### BACKGROUND ART

In the last few years there has been a confluence of digital communications systems involving television and the Internet. In the field of television, advanced digital receivers have been developed capable of receiving and displaying compressed data streams, using MPEG-2 encoding. MPEG compression is a standard developed by the Moving Pictures Expert Group from 1988 to 1990. Distribution of television program material is advancing with the installation of fiber optic cable, satellite links and video servers between cable head ends and subscriber locations. Most program material is currently distributed in analog form, but as more digital receivers are installed, a change to digital format is foreseeable, complete with Internet linkage and subscriber interactivity. Many cable and satellite installations are terminated in a set top box which includes a processor for bi-directional communication with a head end for fetching menus and providing receiver status and generally enabling a vast set of additional communications infrastructure functions. The set top box is always on and is addressable by the head end to request status, send test messages, and listen for subscriber requests.

In the field of Internet communication, there has been explosive growth of the World Wide Web, with thousands of new web sites arising every day. Many of these web sites once provided a limited amount of database material which could be downloaded over common telephone lines. However, with the increasing sophistication of search engines and the desire of media companies to participate in the Internet, program material of the type found on radio and television is now found on the Internet. For example, it is now possible to listen to a live baseball game broadcast via the Internet, or to listen to news clips or see news video clips, all using wire and cable hookups. Of course, many Internet users are not satisfied with bandwidth limitations because search engine performance and transmission bandwidth is slow. Media broadcasts are frequently subject to pauses and system performance and quality are not comparable to analog versions of the same program material found on radio or television. It has been realized that computer monitors are not appropriate vehicles for displaying media program material because the terminals are too small and computer boot-up time is too long. While computer processor power is desirable, screens are too small for groups of people, such as families, to enjoy the program material. On the other hand, even advanced television receivers are not equipped to handle the bidirectional communication used in Internet and advanced interactive television operations.

Unfortunately, the set top box which controls advanced television distribution, and has bi-directional communications available, is not suited to Internet protocol material because there has been no effort to standardize communication methodologies. For one thing, there is a bandwidth mismatch between a typical Internet channel found on an Ethernet cable and a coaxial cable fed to a set top box. This mismatch might lead one to conclude that there would be tremendous waste in linking the Ethernet cable, on the one hand which uses Internet protocol data, and set top boxes, on the other hand which use MPEG frames. However, in recent times media companies are buying stakes in Internet service providers. Even software companies, such as Microsoft, have bought video program sources and are attempting program distribution. During 1997 there was an attempt, led by Microsoft, to establish standards that would have made digital television sets compatible with computer monitors at the expense of high definition television. However, the standards were not adopted and there is now an intense search for ways to deliver media program material, such as film, radio and television broadcasts, and newspaper material via the Internet to television sets in a more effective way than the present crude efforts.

A further problem is that set top boxes manufactured by different organizations are not compatible with each other. While all of them will handle the same program material, different control patterns (protocols, procedures, spectrum allocation, etc.) exists for set top boxes from different manufacturers. With the lack of standards for communication with set top boxes, it has been thought that sophisticated operating systems, such as Windows CE, would be needed for set top boxes to handle compatibility issues. However, such a plan would require redesign of existing set top boxes, making current set top boxes obsolete or awkward contraptions.

An object of the invention has been to devise a bandwidth efficient system for interfacing Internet communications, including audio-visual program material, with advanced television receivers via set top boxes.

Another object of the invention has been to achieve compatibility among existing set top boxes from different manufacturers.

A further object of this invention is to link together and co-manage Internet and interactive television permitting seamless and logical subscriber transitioning between the two mediums.

Another object of this invention is to permit content stream multiplication of video server and satellite streams with or without time displacement permitting multicasting of interactive or non-interactive content to subscribers, thereby significantly reducing the bandwidth requirements, complexity and cost of video server and satellite retransmission facilities.

### SUMMARY OF INVENTION

The above objects have been achieved with an interactive television system featuring a new communications processing encoder located at the head end of a TV program material distribution location. The encoder is connected to receive Ethernet protocol input data frames with Internet protocol addresses. These input frames would carry television program information, such as video from Microsoft's Netshow Theater or other program sources. The encoder maps larger Ethernet addresses to a relatively small MPEG-2 address space, namely the program identification space (PID), by allowing the PID to become a virtual address based upon the name of program content. In essence, the 13 least significant bits of the 32 bit Internet protocol address could become the PID. For example, if the name of a movie requested by a set top box owner is “Titanic”, then a number associated with this film, and only this film, becomes the virtual address for the requesting set top box and all other set top boxes requesting the same movie at the same time. A control computer keeps track of the naming conventions providing new virtual addresses corresponding to new content or movies in the set top boxes. Internet protocol addresses, which are user and program specific, are mapped to MPEG-2 data streams only by program specific information. Once that program is finished, the set top box is reset for a new stream of MPEG-2 encapsulated program material.

Once MPEG-2 frames are created, the frames are multiplexed together and digitally manipulated to be a radio frequency signal at a desired frequency. The digital signal is quadrature amplitude modulated (QAM) within the 6 MHz TV channel bandwidth at a rate of 27 to 36 megabits per second (Mbs). At the 27 Mbs rate, eight digital channels each of 3.375 Mbs can be placed. Eight such digital channels occupy 6 MHz, the space occupied by a single analog television program.

With the encoder of the present invention, compatibility among existing set top boxes is achieved without the requirement for a new operating system or without much additional complex set top box hardware for the set top boxes. Only a small set top box resident application program is required which can be remotely loaded by the encoder. Internet communications, including audio-visual program material, Nay then be delivered to television receivers via ordinary digital set top boxes decoding MPEG-2 bit-streams, just as they now do, and an uplink may transmit interactive viewer responses to the cable head end.

Several encoders can have different radio frequency outputs stacked by a combiner and transmitted as a single wideband signal. This allows multiple threads of video program material to be transmitted simultaneously or multiple copies of the same thread to be transmitted with time delays between threads for either video-on-demand (VOD) or near-video-on-demand (NVOD) applications.

### BRIEF DESCRIPTION OF THE DRAWINGS

FIG. 1 is a block diagram of a simplified arrangement of the system of the present invention.

FIG. 2 is a block diagram of a typical arrangement of the system or the present invention.

FIG. 3 is a block diagram of a complex arrangement of the system of the present invention.

FIG. 4 is a data diagram illustrating conversion of Ethernet frames into MPEG-2 bit-stream segments in accord with the present invention.

FIG. 5 is a transmitted radio frequency baseband diagram illustrating packing of television channel slots using the system of the present invention.

FIG. 6 is a flow chart illustrating packaging of varied Ethernet data frames into MPEG-2 data for transmission to set top boxes.

### BEST MODE FOR CARRYING OUT THE INVENTION

With reference to FIG. 1 a data encoder 11 is located at the head end of a TV program material distribution terminal. The encoder 11 is a data transceiver which receives digital input data, in Ethernet format, from a content server 13 over digital communications link 15. The encoder converts the Ethernet format data to MPEG-2 data bit-streams as explained below. The encoder has a transmit side connected to diplexor 17 under the control of a computer 19, also located at the head end. Distant from the head end are a number of set top boxes 21 to which the encoder output signals are transmitted through the diplexor. The diplexor 17 separates upstream data from set top boxes 21 and diverts the data to control computer 19 so that none of the upstream data enters encoder 11. At the same time, diplexor 17 allows downstream data from encoder 11 to reach set top boxes 21.

Encoder 11 functions to receive data from various sources, some of which is packaged as internet protocol data, but all of it arriving in Ethernet data frames. Ethernet data frames are defined as an industry standard and are the most common frames for the transmission of data over networks. The chief function of encoder 11 is to receive Ethernet data frames and convert such frames to an MPEG-2 bit-stream. Present day digital set top boxes 21 can all read MPEG-2 bit-streams and, using downloaded application software, display corresponding video program material. In this manner, encoder 11 serves to establish a data format which can be simply read by existing digital set top boxes, even though the input sources may be varied and incompatible with set top boxes if used directly.

In FIG. 1 the boundary of the head end of a television program distribution system is the diplexor 17. The set top boxes 21 are located remote from diplexor 17 at subscriber locations. Thus, by packaging data for the set top boxes at the encoder, it is seen that common formatting for the set top boxes is done at the head end location, rather than at the set top boxes. In the prior art, it has been contemplated that data incompatibilities would be resolved at set top boxes. The present invention takes the approach that incompatibilities and efficiency gains are resolved at the head end with an encoder which maps Ethernet data frames to MPEG-2 bit-streams. Additional functionality of the encoder is its ability to (1) provide logical linkages between Internet and MPEG2 programming and (2) to provide multiplication of singular streams from content servers for time or non-time displaced multicasting purposes.

The set top boxes can transmit user requests for program material via diplexor 17 to control computer 19. The control computer tracks billing information and sends the request to the content server 13 which produces a requested video program. The requested video program material is transmitted to encoder 11 on line 15.

The content server may be a video server, such as a film server or any source of video program material. Usually such material is recorded for storage on a server so that the material can be called up under the command of control computer 19 sending signals requesting specific video program material along line 25. Such requested material is received by encoder 11 and converted to MPEG-2 bit-streams at appropriate radio frequencies compatible with reception by the set top boxes 21.

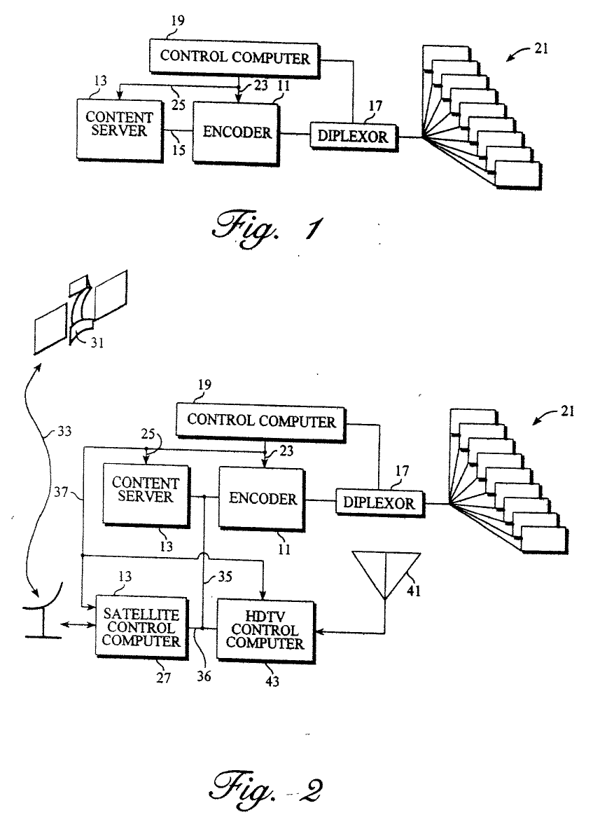

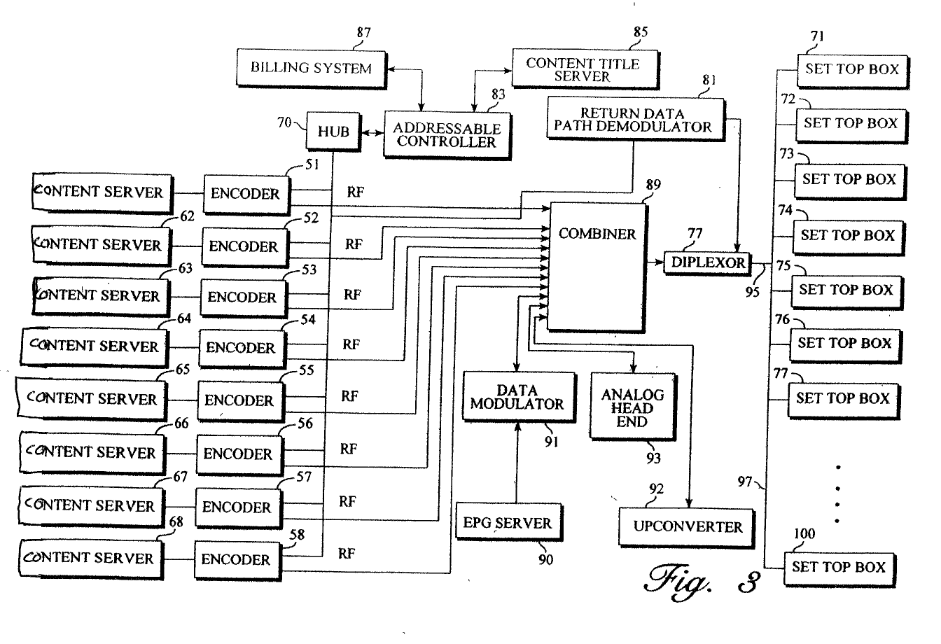

In FIG. 2, content server 13 is connected in parallel with satellite control computer 27 feeding signals to encoder 11. Signals fed to encoder 11 are in Ethernet format at 100 base T rates. Satellite control computer 27, of conventional design, is connected to a satellite signal receiver 29, depicted as an antenna, receiving video program information from earth satellite 31 via the ultra-high frequency data link 33. Satellite 31 may transmit network feed program material to content server 13 or to encoder 11, or both. The content server 13 can store the program material for use at a later time. Alternatively, the video program material may be relayed from television stations and sent either to the content server 15, or the encoder 11, or both. Data from the satellite communications system is received and processed by the computer 27 which produces an Ethernet stream for transmission to encoder 11 along the network line 35. Control computer 19 communicates with both content server 13 and satellite control computer 27 using Ethernet protocol via line 37 to communicate selected requests for program material coming from diplexor 17 which receives such requests from set top boxes 21. Each of the set top boxes is associated with a television set receiver, acting as a subscriber to the program material. High Definition Television program material may be received by a high frequency VHF or UHP antenna 41 which transmits a radio frequency signal to a format conversion control computer 43 which includes a digital scan converter and a format conversion program which places the digital information in Ethernet frames. Line 37 is connected to the format conversion control computer 43 for delivering digital HDTV television program material to the encoder. Such requests indicate the requester which becomes part of the address for Ethernet frames transmitted out on line 36 into Ethernet network line 35 for communication to the encoder 11 and can be used to create a billing database.

With reference to FIG. 3 each of the encoders 51, 52, 53 . . . , 58 can be seen having an input line connected to a content server 61, 62, 63 . . . , 68, respectively. The content server is a video program server having video program material such as Microsoft Netshow Theater. Program material is transmitted to a respective encoder in Ethernet format. Each content server may also have other video program material which is fed to a respective encoder, with each encoder receiving inputs from an Ethernet hub which, for the sake of simplicity, is not shown but which is handling upstream information coming from diplexor 77 connected to set top boxes 71, 72, 73 . . . , 100. Upstream information may be a request for support specific video program material which is transmitted through diplexor 77 to the return path demodulator 81 which transmits the signal to addressable controller 83 via a content title server 85 which provides unique subscriber program unlocking and descrambling information. The content title server, which is used by both the encoder and the set top boxes, provides orientation to the appropriate content as well as providing conditional access and encryption decoding information. The addressable controller 83 also performs bookkeeping functions and may have a database for a billing system 87 which tracks user charges for invoicing purposes. Ethernet hub 70 receives an input from each of the encoders 51-58 and, under control of addressable controller 83 specifies radio frequencies for encoder output signals of bit-streams transmitted to combiner 89.

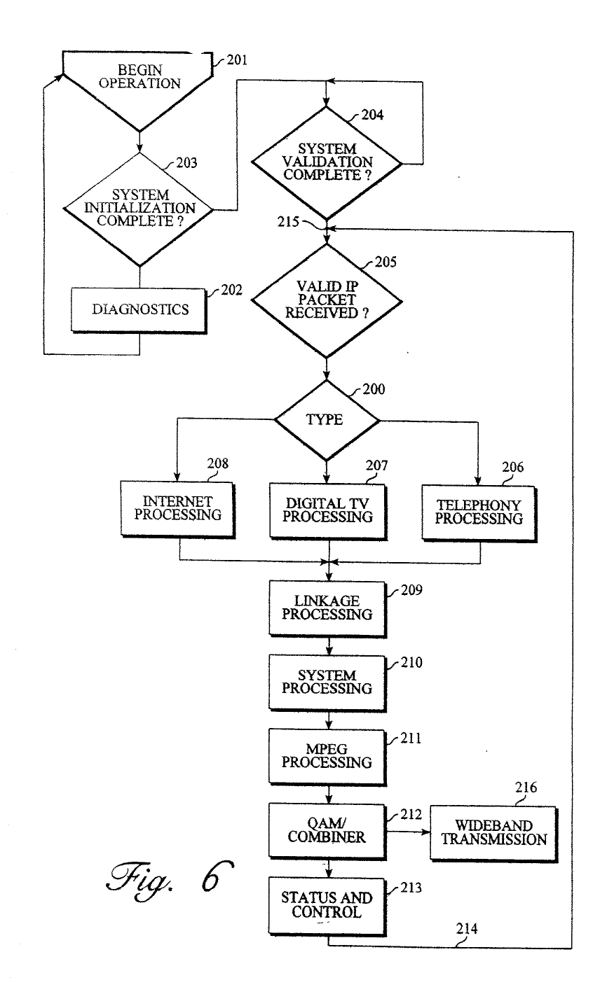

The series of encoders 51, 52, 53 . . . , 58 each converts Ethernet data with internet protocol coming from a respective content server into an MPEG-2 bit-stream within a specified radio frequency bandwidth. Each encoder has a single radio frequency (RF) output line connected to the signal combiner 89 which stacks the encoder output signals to form a single composite wideband signal which has been modulated by a group of quadrature amplitude data modulators resident in each encoder 91 also connected to combiner 89 when multiple encoders are used. An up-converter 92 is used to stack digital channels into 6 MHz bands and then to stack the 6 MHz bands among 6 MHz analog or digital channels as shown below in FIG. 5. An electronic program guide (EPG) server 90 is provided as a separate digital channel to data modulator 91. EPG server provides a data base of program material from which a subscriber, using a set top box, can select desired program material. Once selected, the subscriber's choice is sent through a set top box to diplexor 77 and then to the return path demodulator 81 and to the addressable controller 83 which fetches program material from a content server. Combiner 89 also receives signals from analog and digital head ends permitting the concurrent use of both digital and analog set top boxes. This concurrent use of analog and digital set top boxes permits orderly subscriber migration from analog to digital set top boxes. In hybrid systems, it is necessary to provide frequency space among the program channels for analog channels. The output of combiner 89, a plethora of wideband RF signals, is fed to diplexor 77 which is at the head end. The output of diplexor 77 is a path 95 for distribution of the head end signal over a bus 97 to the set top boxes 71, 72, 73 . . . , 100 which are usually remote from diplexor 95. The bus 97 may be a coaxial cable, a fiber optic cable, a radio link or any of the well known digital signal distribution facilities. Each set top box has a radio frequency tuner and digital demultiplexor to extract individual MPEG-2 bit-streams from the frequency stacked, wideband signal. Each set top box also has an MPEG-2 decoder. For any existing set top box not having these features, these signals could not be extracted.

The encoder permits any connected content servers to deliver any content to any interconnected set top box through a signal combiner and diplexor. Since the encoder permits both point to point (private communications) and/or multi-point shared session communication, i.e. stream sharing/multicasting, a single content stream can be shared by multiple subscribers, or the content can be exclusively sent to a single subscriber. With the encoders random access memory, it can optionally store and retransmit streams. This facilitates dynamic stream multiplication, a feature which permits taking a single stream from the content server and creating multiple time or non-time displaced streams to subscribers so that secondary VOD subscribers do not require additional streams from the content server. This enables multiple VOD subscribers to view the Same movie at slightly different times while requiring the content server to produce only one stream of the content at a time. The encoder will have attached random access storage to permit this additional buffering of content while it is in use, relieving the work load on the attached server permitting the system to deliver more streams than would otherwise be possible by the server or servers alone.

The encoder 11 and the control computer 19 work together in VOD applications. Internal random access memory in the encoder permits the multiplication or replication of streams of different time displacements from the server thereby permitting multiple content streams to be delivered multiple places at different but more convenient times for a subscriber facilitating both Near Video On Demand and True Video On Demand. The capacity of many servers would be exceeded without this stream multiplication function.

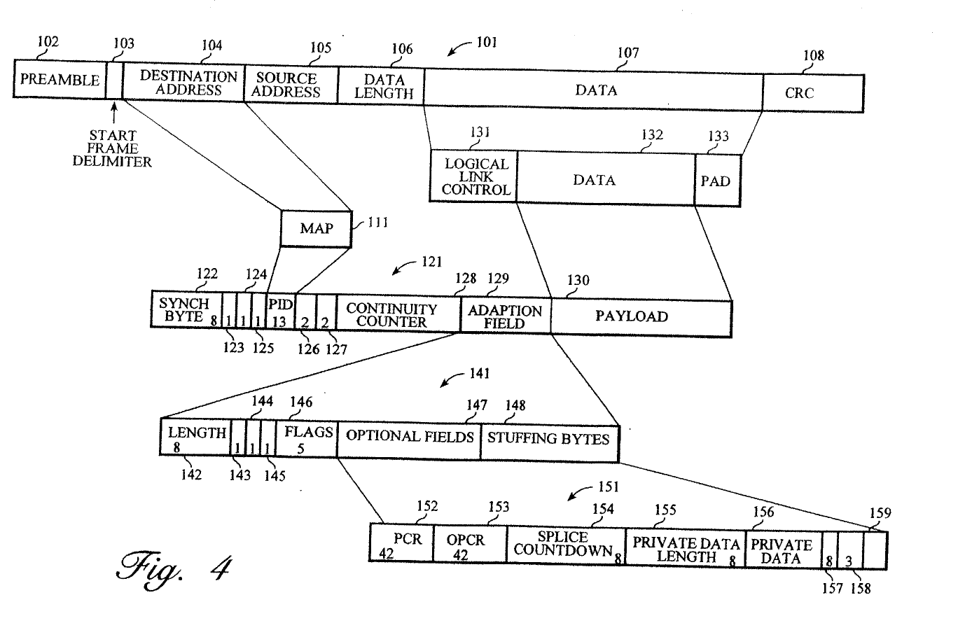

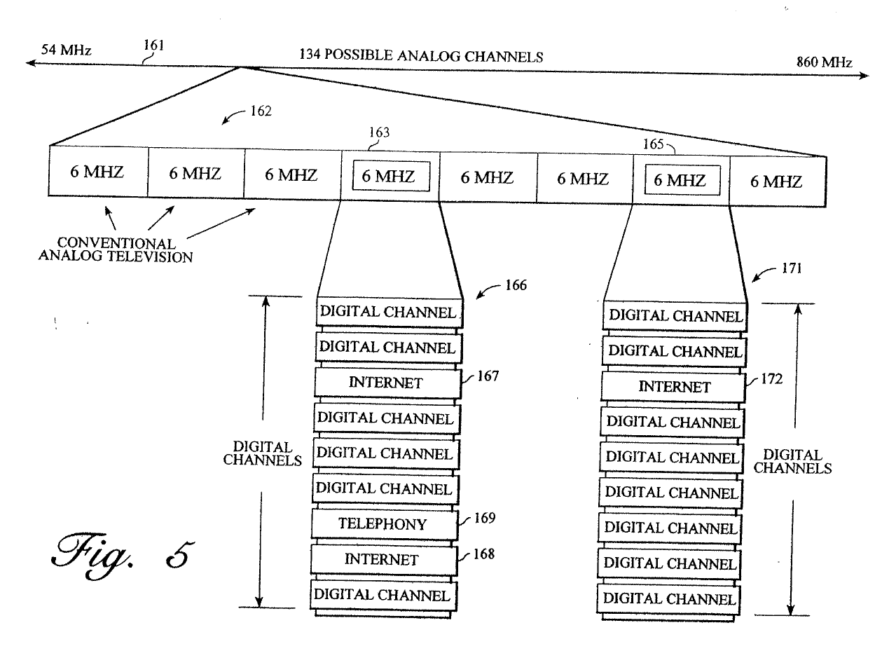

FIG. 4 shows the conversion of Ethernet data to an MPEG bit-stream. The data frame 101 is an Ethernet frame having a preamble segment 102, a start frame delimiter 103, a destination address 104, a source address 105, a data length segment 106, a data portion 107 and an error correcting section 108. Of particular interest is the destination address 104 which is normally 32 data bits long. This address is mapped, by software 111 to the MPEG bit-stream frame 121 having a 13 bit segment 122 known as a program identification segment. The mapping performed by software 111 transforms the destination address to represent the name of a particular video program by means of the mapping routine 111. The mapping routine creates a virtual address by using a unique number associated with specific program material in place of the former address whereby all actual destinations which request the same video program material at the same time would receive the same program identification packet in MPEG-2 bit-stream frame 121. The idea of virtual addresses is known. In this application, since the MPEG2 PID cannot represent the total universe of video content, but rather only a limited 2**13 or 8192 movies or pieces of content, the larger IP address is remapped on a regular basis to this smaller subset of content which is adequate for usually at least a few days. For example, a movie one week may have a different virtual address the next week. All that is required is that during one period of time, one movie or content piece have one unique virtual address.

The MPEG-2 data frame has an 8-bit synchronization byte 122, a single bit transport error indicator 123, a single bit payload unit start indicator 124, a single bit priority indicator 125, a two bit descrambling control 126, a two bit adaptation field control 127, a continuity counter 128, an adaptation field 129 and a payload section 130. The payload section 130 is copied from the data section 107 of the Ethernet frame. That data section has a logical link control section 131 which is stripped, a central data section 132 which is mapped to payload section 130 and padding bits 133 which are stripped.

The adaptation field 129 of the MPEG bit-stream frame is shown as section 141 having a length indicator 142, a single bit discontinuity indicator 143, a random access indicator 144, and a single bit packetized elementary stream (PES) indicator 145. Five bits are allowed in flag segment 146. Optional fields are provided in section 147 and stuffing bytes are provided in section 148. The optional field segment 147 is shown in the expanded frame section 151 with a 42 bit program clock reference section 152, a 42 bit section 153 for Original Program Reference Clock (OPCR), an 8 bit splice countdown section 154, an 8 bit private data section 155 and a similar section 156 as well as an 8 bit field extension length 157, a 3 bit flag section 158 and an optional field section 159. Information which is not present in the Ethernet data frame is generated by the encoder inasmuch as most of the material is of a housekeeping nature involving splices, flags and status of bits. A major concern is converting the destination address to a video program identifier by the mapping routine 111, as well as the transfer of the data section 107 to the MPEG-2 payload section 130.

With reference to FIG. 5, it is seen that the television base band, represented by line 161 normally extends between 54 MHz and 860 MHz. A typical 6 MHz analog channel 162 is shown in expanded format. Within band 163 eight digital channels 166, 167, 168 and 169 have been extracted to show utilization by digital channels in accordance with known technology. Among the digital channels could be two Internet protocol channels 167 and 168 which would be fed to encoders of the present invention to produce MPEG bit-streams which would fit within the frequency allocation of the digital channel. similarly, a digital telephony channel 169 formatted with Internet protocol frames could be run through an encoder of the present invention and transmitted as MPEG data in slot 169.

Analog channel 165 has been allocated as a slot for eight digital channels 171 including one slot 172 for Internet protocol data run through an encoder of the present invention which appears with other dedicated digital channels. The other channels, if transmitted with Internet protocol frames could be run through the encoder of the present invention. Alternatively, the digital TV channels may remain separate and be combined at a head end with material coming through encoders of the present invention.

With reference to FIG. 6, a sequence of operations is shown for operating the encoder of the present invention. Initialization block 201 is triggered when the system is turned on, with a preliminary diagnostics check indicated by block 202 which triggers a signal through decision node 203 when favorable system initialization is complete. Upon receipt of an initialization signal, the validation block 204 looks for input information, including valid Internet protocol packets which are checked at block 205. The type of data is examined with an inquiry at decision node 200 regarding telephony, indicated at block 206, television indicated at block 207, and web or similar Internet data in block 208. Destination addresses are converted to program identifiers in block 209, with further synchronization, flag, error correction and clocking established in block 210. MPEG-2 bit-stream frames are assembled in block 211 for modulation which occurs at the quadrature amplitude modulator 212. Wideband signal transmission occurs at this point, as indicated by block 216. The entire process is under supervision of a control block 213 which validates the entire operation. A line 214 provides feedback to node 215 to ensure that each MPEG2 packet is properly encapsulated, coded and modulated, and the process continues in this loop over and over.

By converting the Internet Protocol of the Ethernet packets to MPEG2 compliant encapsulation packets, a simple compatibility solution can be found for mixing a variety of different signals for transmission to set top boxes of varying manufacturers which minimizes set top box programming and memory requirements but more importantly maximizes communications infrastructure efficiency. Communications infrastructure efficiency enhancement is achieved when at certain times, more Internet bandwidth is required and less bandwidth is required for digital television, or vice-versa. The encoder system continually assesses or monitors bandwidth for the different Internet, telephony and digital television requirements and dynamically and automatically allocates or deallocates those communications resources on a demand basis. All existing set top boxes can decode MPEG frames. So, all of such set top boxes can continue to operate as normal. CATV modems require a fixed spectrum bandwidth, so bandwidth cannot be dynamically reallocated between services (Internet, TV, telephony) when more is required and additional unused bandwidth would otherwise be available from digital television or television allocations. Some existing set top boxes provide interactive elements, such as menus and product information indicia which is directed directly to a screen. Currently these can come from an EPG server, but now the option exists to obtain these menus and a more vast superset from the Internet using existing standard Internet browsers. A user can signal any indicia of interest by commanding certain set top boxes to fetch information from the head end which is now linked to the Internet. A remote website can provide product information which is sent back in Ethernet packets to the head end where it is run through the encoder of the present invention and converted to MPEG format for display on the television screen, perhaps in a small portion of the screen or a split screen or optionally on a computer compatible interface on the set top box enabling and communicating with a personal or other computer. For example, in a baseball game, a roster of players on the field may be listed on the screen using the EPG server and a user can signal whether he wishes more information on a particular player. Upon such signalling, the set top box would fetch a web page related to the particular player of interest and statistics or other information about the player could be displayed on the split screen. The present invention achieves that capability remote from the set top box by converting the return Ethernet data to MPEG bit-streams which can be interlaced with video program material and separated by a decoder in the set top box. Each set top box has a decoder which separates audio from video and can also separate Internet data for display or presentation in an appropriate format, such as sound or a split screen portion of a television receiver. The encoder can dynamically link Internet Packets and MPEG2 Packets to provide linked functions which begin on either the Internet or the Digital Television system. The analogy would be linking or conditionally synchronizing content in big pipes to little pipes where the little pipes had more universal content, but less ability to distribute it, therefore relying for major throughput on the big pipes. The encoder is the facilitator of this process.

The present video encoder invention, when ganged together in a parallel arrangement with connections to several video program sources, allows comprehensive, large-scale video-on-demand (VOD) or near-video-on-demand (NVOD) program presentation. Single threads of video program material may be fed to multiple set top boxes, thereby replicating the thread. Because multiple digital channels may be combined in a single analog TV slot, many video program threads may be similarly replicated. Alternatively, the same thread may be repeated, on a time delayed basis, on different channels which are simultaneously transmitted. This would satisfy “on demand” subscribers

1. An interactive television system comprising,
a television head end distribution terminal with input lines having program material in Ethernet frames with Internet protocol addresses as inputs and with multiple cable output lines,
an encoder disposed at the head end distribution terminal mapping the Ethernet frames with Internet protocol address spaces to encapsulated MPEG-2 bitstreams with address spaces smaller than the Internet protocol address spaces, the encoder having an output feeding the MPEG-2 encapsulated bitstreams to the cable output lines, and
a plurality of television set top boxes connected to the cable output lines, each set top box having an MPEG-2 decoder.

2. The system of claim 1 wherein said encoder has diverse sources for said Ethernet frames, including Internet sources and MPEG2 sources, thereby linking Internet IP addresses and MPEG2 addresses and consolidating two communications protocols.

3. The system of claim 1 having a plurality of said encoder ganged together in a manner multiplying content streams from a program source.

4. The system of claim 3 wherein said multiplied content streams are time displaced.

5. The system of claim 3 wherein said multiplied content streams are transmitted to multiple set top boxes.

6. The system of claim 3 wherein said multiplied content streams are transmitted to a single set top box.

7. The system of claim 1 further comprising an upstream communications link between the set top boxes and the head end.

8. The system of claim 1 further comprising at least one video program material server connected to the encoder.

9. The system of claim 8 comprising a satellite program material input line connected to the encoder.

10. The system of claim 9 further comprising a satellite data management computer interfacing data in the satellite program material input line with the encoder.

11. The system of claim 1 further comprising a control computer connected to the encoder.

12. An interactive television system comprising,
a television head end distribution terminal with input lines having program material in Ethernet frames with Internet protocol addresses as inputs and with multiple cable output lines terminating in a signal combiner,
a plurality of encoders disposed at the head end distribution terminal, each encoder mapping the Ethernet frames with Internet protocol address spaces to MPEG-2 bit-streams with address spaces smaller than the Internet protocol address spaces, each encoder having an input from a source of Video program material and an output feeding the MPEG-2 bit-streams to the cable output lines, the frequencies of the bit-streams from the plurality of encoders being different from each other, spanning a frequency band, and
a plurality of television set top boxes connected to the combiner, each set top box having a radio frequency selector and digital multiplexor to extract individual MPEG-2 bit-streams and an MPEG-2 decoder under control of specific downloaded software from the encoder.

13. The system of claim 12 further comprising an upstream communications link between the set top boxes and the head end.

14. The system of claim 12 further comprising an Ethernet hub connected to receive an input from each of the encoders and connected to an addressable controller having means for specifying frequencies for said bit-streams.

15. The system of claim 14 wherein said addressable controller is connected to a content title server.

16. The system of claim 12 wherein data modulators and up converters are connected to the combiner for combining groups of digital channels on specific radio or television frequency channels.

17. The system of claim 12 wherein digital output of said encoders is sent to the combiner together with analog channels, thereby permitting continuing operation of non-digital set top boxes.

18. A method of transmitting Internet data to television set top boxes comprising,
formatting the Internet Protocol (IP) of the Ethernet data frames to MPEG2 encapsulated packets including the formulation of new addresses from IP packets to MPEG2 packets by mapping the Ethernet data frame (IP) addresses to an MPEG-2 bit-stream PID address, and mapping the Ethernet data frame data bits to an MPEG-2 bit-stream payload segment following a corresponding MPEG-2 bit-stream address.

19. The method of claim 18 further defined by converting each Ethernet data frame address to a virtual address associated with specific video program material and assigning said virtual address as an MPEG-2 bit-stream address.

20. An interactive television method comprising,
producing multiple content streams from singular content streams of video program material furnished from video servers or satellite down-links, and
providing a plurality of said content streams for subscribers available in stream sharing and point to point applications, wherein stream multiplication by stream sharing for multiple session true video on demand occurs without subscriber awareness that stream sharing is in progress.

21. The method of claim 20 wherein said stream multiplication is during a single time interval.

22. The method of claim 20 wherein said stream multiplication is during staggered time intervals.

23. A method of digital data communication comprising monitoring the bandwidth employed by digital television, Internet and telephony activity and dynamically adjusting or allocating bandwidth between the services as needed.
